(19) United States
(12) Patent Application Publication
(10) Pub. No.: US 2012/0204382 A1
(43) Pub. Date: Aug. 16, 2012

(54) Rope Fixer Allowing Easy Adjustment of a Rope

(76) Inventor: Ying-Ching Wu, Tainan (TW)

(21) Appl. No.: 13/024,451

(22) Filed: Feb. 10, 2011

(51) Int. Cl. F16G 11/00

(52) U.S. Cl. 24/129 R

(57) ABSTRACT

A rope fixer includes first and second ends spaced along a longitudinal axis and an outer periphery extending between the first and second ends. The rope fixer further includes first, second, and third through-holes extending through the outer periphery and spaced from each other along the longitudinal axis. Each of the first, second, and third through-holes includes first and second openings spaced in a circumferential direction surrounding the longitudinal axis. The rope fixer frictionally retains a section of a rope that extends through the first, second, and third through-holes.

### BACKGROUND OF THE INVENTION

The present invention relates to a rope fixer and, more particularly, to a rope fixer preventing loosening of a rope and allowing easy adjustment of the tightness of the rope.

Ropes are commonly used in daily life to tie things up. As an example, ropes are used on posts of tents or tennis nets to support the tents or the tennis nets. Ropes can be knotted in various ways according to differing situations. However, many people do not know the knotting methods. In a case that ropes are used to tie up goods or furniture on a truck during transportation, the furniture or goods are still liable to slide or even fall from the truck due to insecure tying of the ropes while the truck bumps on the road. In another case that two ropes are used to fix two posts of a tent, an end of each rope is attached to an upper end of one of the posts, and the other end of each rope is wound around a spike or the like that digs into the ground. Adjustment of the tightness of the ropes is often required before the tent reaches a balanced state. However, the adjustment requires troublesome untying and retying of the ropes.

Thus, a need exists for a rope fixer preventing loosening of a rope and allowing easy adjustment of the tightness of the rope.

### BRIEF SUMMARY OF THE INVENTION

The present invention solves this need and other problems in the field of rope tightening by providing, in a preferred aspect, a rope fixer including first and second ends spaced along a longitudinal axis and an outer periphery extending between the first and second ends. The rope fixer further includes first, second, and third through-holes extending through the outer periphery and spaced from each other along the longitudinal axis. Each of the first, second, and third through-holes includes first and second openings spaced in a circumferential direction surrounding the longitudinal axis. The rope fixer is adapted to frictionally retain a section of a rope. The section of the rope is adapted to extend through the first, second, and third through-holes.

In a form shown, the rope fixer further includes a fourth through-hole extending through the outer periphery. The first through-hole is located adjacent the first end, the fourth through-hole is located adjacent the second end, and the second and third through-holes are located between the first and fourth through-holes. Furthermore, the second through-hole is located between the first and third through-holes. A first spacing between the first and second through-holes along the longitudinal axis is in a range of 0.5 to 1 times a second spacing between the second and third through-holes along the longitudinal axis. A third spacing between the third and fourth through-holes along the longitudinal axis is in a range of 0.5 to 1 times the second spacing between the second and third through-holes.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a rope fixer according to the present invention and a rope.

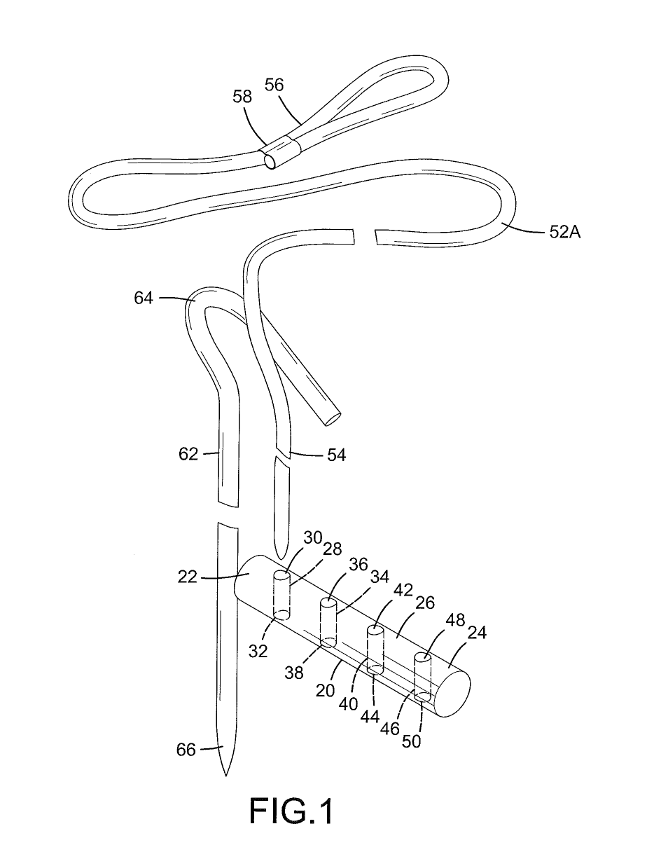

FIG. 2 shows a perspective view of a tent using a plurality of rope fixers according to the present invention.

FIG. 3 shows a partial, enlarged view illustrating use of the rope fixer of FIG. 1.

FIG. 4 shows a view similar to FIG. 3, with the rope in a loosened state for adjustment.

FIG. 5 shows a view similar to FIG. 3, with the rope wound around the rope fixer and a spike in a different way.

FIG. 6 shows a view similar to FIG. 3, with the rope wound around the rope fixer and the spike in another way.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “fourth”, “lower”, “upper”, “top”, “bottom”, “side”, “end”, “section”, “longitudinal”, “circumferential”, “spacing”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

A rope fixer according to the present invention is shown in the drawings and generally designated 20. Rope fixer 20 includes first and second ends 22 and 24 spaced along a longitudinal axis. Rope fixer 20 further includes an outer periphery 26 extending between first and second ends 22 and 24. Rope fixer 20 further includes first, second, third, and fourth through-holes 28, 34, 40, and 46 each extending through outer periphery 26 in a diametric direction perpendicular to the longitudinal axis. First, second, third, and fourth through-holes 28, 34, 40, and 46 are located between first and second ends 22 and 24 and spaced from each other along the longitudinal axis. Specifically, first through-hole 28 is located adjacent first end 22, fourth through-hole 46 is located adjacent to second end 24, and second and third through-holes 34 and 40 are located between first and fourth through-holes 28 and 46. Furthermore, second through-hole 34 is located between first and third through-holes 28 and 40. A spacing between first and second through-holes 28 and 34 is in a range of 0.5 to 1 times of a spacing between second and third through-holes 34 and 40. Furthermore, a spacing between third and fourth through-holes 40 and 46 is in a range of 0.5 to 1 times the spacing between second and third through-holes 34 and 40. According to the form shown, first, second, third, and fourth through-holes 28, 34, 40, and 46 have identical diameters and spaced from each other at regular intervals.

According to the form shown, first through-hole 28 includes first and second openings 30 and 32 formed in outer periphery 26 and spaced in a circumferential direction about the longitudinal axis. Likewise, second through-hole 34 includes first and second openings 36 and 38 formed in outer periphery 26 and spaced in a circumferential direction about the longitudinal axis. Third through-hole 40 includes first and second openings 42 and 44 formed in outer periphery 26 and spaced in a circumferential direction about the longitudinal axis. Fourth through-hole 46 includes first and second openings 48 and 50 formed in outer periphery 26 and spaced in a circumferential direction about the longitudinal axis.

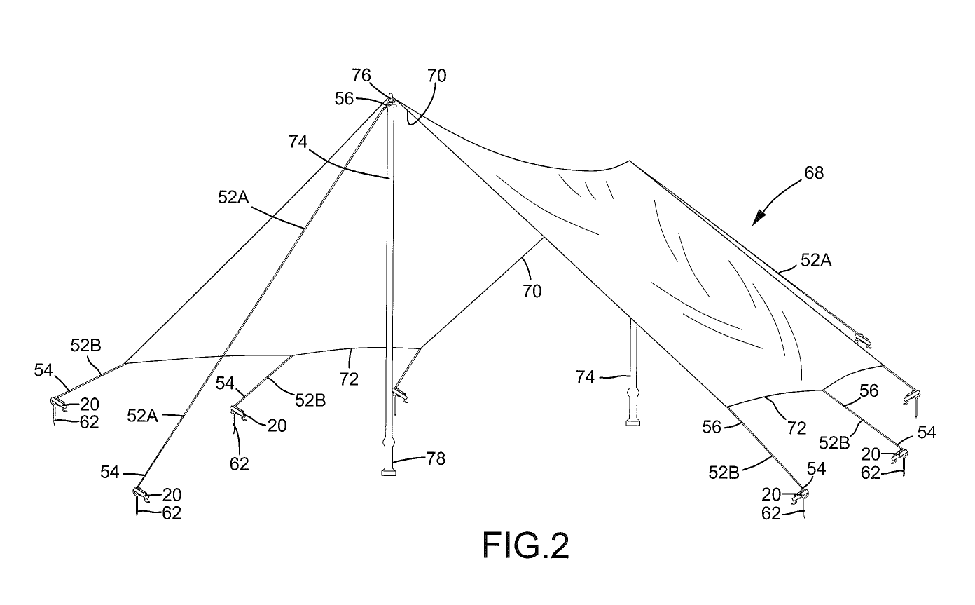

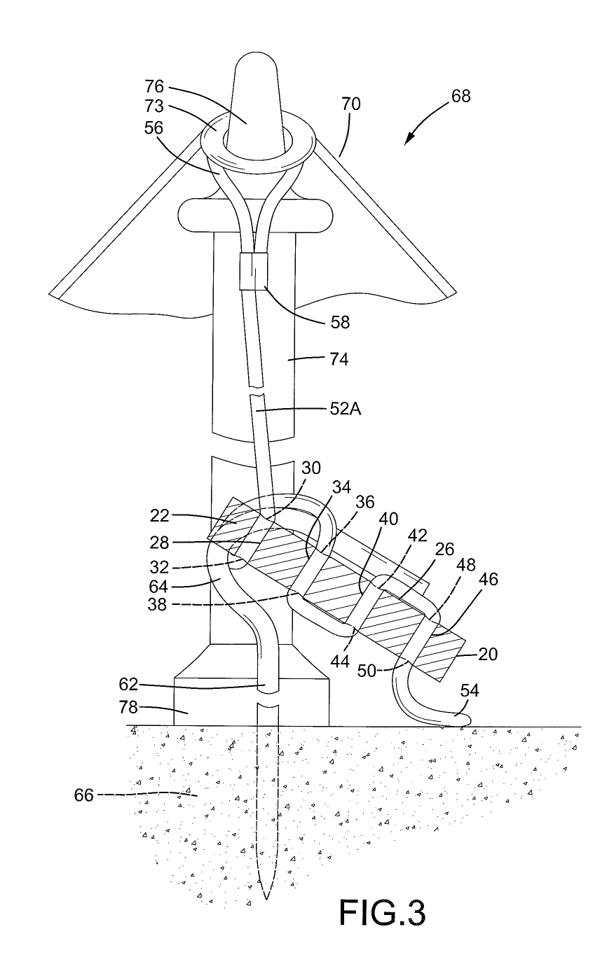

Rope fixer 20 prevents loosening of a rope attached thereto without the need of knotting the rope. FIG. 2 shows an example of use of rope fixers 20 on first and second ropes 52A and 52B of a tent 68 to prevent loosening of first objects 62 such as spikes. Tent 68 includes two spaced first sides 70 and two spaced second sides 72 extending between first sides 70. A plurality of first objects 62 cooperates with first and second ropes 52A and 52B to fix tent 68. Each first object 62 includes a hooked top end 64 and a pointed bottom end 66 that can dig into the ground and, thus, be fixed. A ring 73 is provided at an intermediate portion of each first side 70 of tent 68. Two second objects 74, such as two posts, are provided and each includes an upper end 76 to which ring 73 is mounted and a lower end 78 standing on the ground. A first rope 52A is mounted between upper end 76 of each of second objects 74 and one of first objects 62. Each first rope 52A includes first and second sections 54 and 56. Second section 54 is in the form of a loop mounted around upper end 76 of one of second objects 74. A holder 58 is mounted to and slideably receives second section 56. Second section 56 is pulled to be tightened around upper end 76 of second object 74 after it is mounted around upper end 76 of second object 74. First section 54 of each first rope 52A is extended through first through-hole 28 and wound around rope fixer 20 and top end 64 of first object 62 without knotting. Then, first section 54 is extended through second, third, and fourth through-holes 34, 40, and 46 with a distal end of first section 54 exposed outside of rope fixer 20, as shown in FIG. 3. Outer periphery 26 of rope fixer 20 abuts against top end 64 of first object 62. Sufficient friction avoiding unintentional movement of first rope 52A is obtained by winding first section 54 of first rope 52A through first, second, third, and fourth through-holes 28, 34, 40, and 46. Furthermore, first rope 52A is tightened and reliably wound around top end 64 of first object 64.

A plurality of second ropes 52B has an upper end sewn to each of second sides 72 of tent 68. A lower end of each second rope 52B is wound around top end 64 of one of first objects 62 and one of rope fixers 20 in a manner similar to first rope 52A. Specifically, each second rope 52B has a first section 54 extended through first, second, third, and fourth through-holes 28, 34, 40, and 46 of one of rope fixers 20, preventing second rope 52B from loosening from second object 62. Bottom ends 66 of second objects 62 associated with second ropes 52B are fixed to the ground. Thus, tent 68 is pitched and is triangular when viewed from two lateral sides.

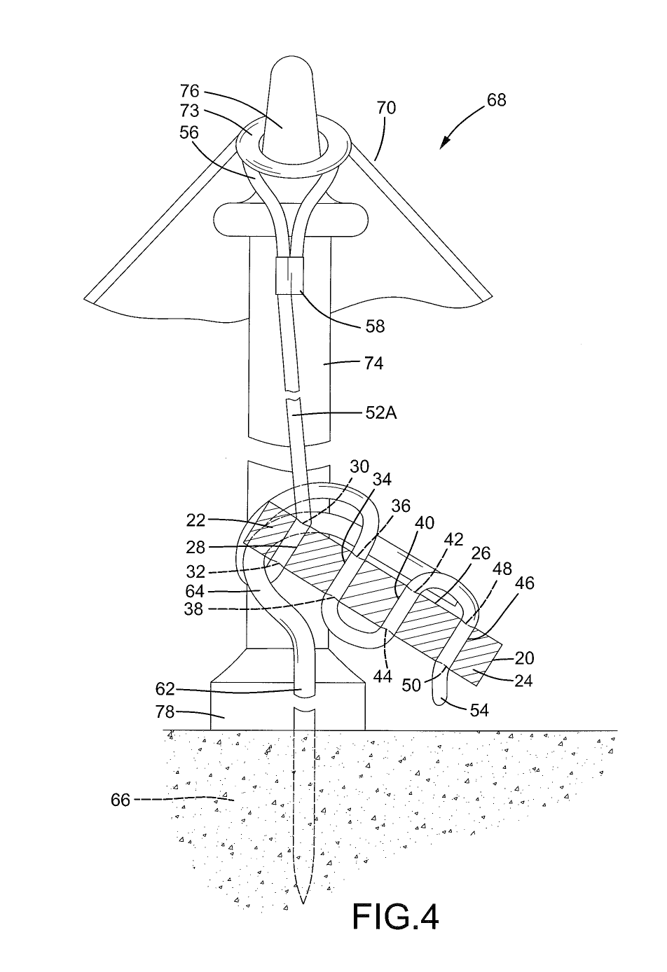

In addition to preventing loosening of ropes, rope fixer 20 also allows slight adjustment of tightness of the ropes. Taking one of first ropes 52A as an example, first section 54 of first rope 52A is loosened from fourth, third, second, and first through-holes 46, 40, 34, and 28 in sequence, as shown in FIG. 4. Then, the loosened part of first section 54 is pulled away from first opening 30 of first through-hole 28, retightening first section 54 in fourth, third, and second through-holes 46, 40, and 34 against outer periphery 26 of rope fixer 20. Thus, first section 54 has a larger length from first opening 30 of first through-hole 28. Second section 56 of first rope 52A is subjected to tensile force, such that a part of first rope 52A wound around outer periphery 26 of rope fixer 20 and top end 64 of first object 62 is tightened again and presses against outer periphery 26 of rope fixer 20 and top end 64 of first object 62. Second rope 52B can be adjusted in the same manner. Since a part of first or second rope 52A, 52B in second, third, and fourth through-holes 34, 40, and 46 creates sufficient friction after it is tightened, unintentional pulling of first section 54 of first or second rope 52A, 52B is avoided. Thus, the tightness of first or second rope 52A, 52B can be slightly reduced. On the other hand, if it is desired to slightly increase the tightness of first or second rope 52A, 52B, the part of first section 54 of first or second rope 52A, 52B in the first through-hole 28 can be pulled out via second opening 32. Then, first section 54 is pulled through second, third, and fourth through-holes 34, 40, and 46 to retighten first section 54, easily increasing the tightness of first or second rope 52A or 52B.

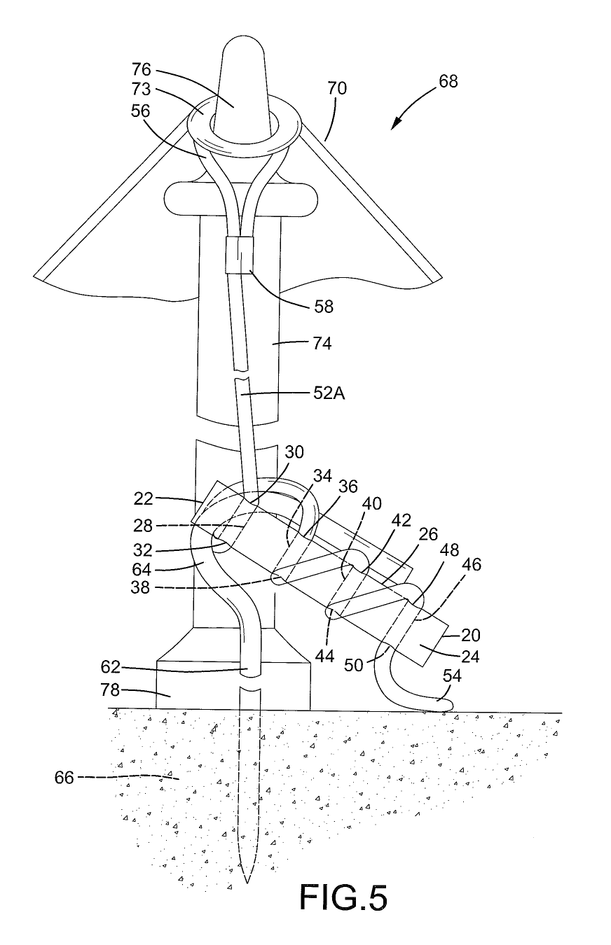

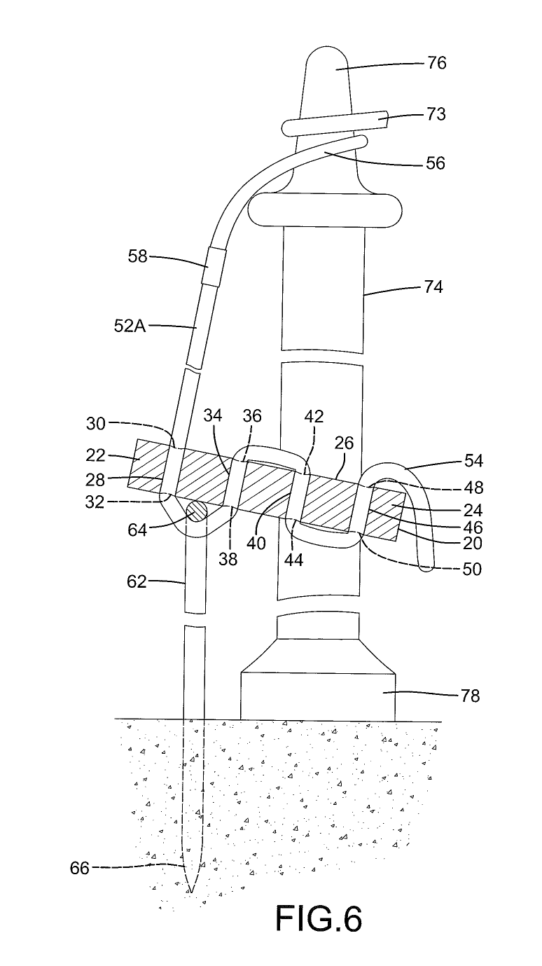

It can be appreciated that ropes can be extended through first, second, third, and fourth through-holes 28, 34, 40, and 46 in other ways. In an example shown in FIG. 5, first section 54 is helically wound around rope fixer 20 in addition to extending through first, second, third, and fourth through-holes 28, 34, 40, and 46. In another example shown in FIG. 6, top end 64 of first object 62 tightly presses against outer periphery 26 of rope fixer 20 by a part of first section 54 between second opening 32 of first through-hole 28 and second opening 38 of second through-hole 34. The winding method shown in FIG. 6 allows easier adjustment of the tightness of rope 52A, 52B while the winding methods shown in FIGS. 3-5 create lager friction to retain first and second ropes 52A and 52B in place.

It can be appreciated that rope fixer 20 can be used in situations other than tent 68. As an example, rope fixer 20 can be used on ropes for tying goods on a truck.

Now that the basic teachings of the present invention have been explained, many extensions and variations will be obvious to one having ordinary skill in the art. For example, rope fixer 20 does not have to include fourth-through hole 46. Diameters of first, second, and third through-holes 28, 34, and 40 are substantially the same as the outer diameter of the rope. Thus, sufficient friction can still be provided. Furthermore, rope fixer 20 can include more than four through-holes if desired. Further, first, second, third, and fourth through-holes 28, 34, 40, and 46 can have cross sections other than circular, such as rectangular, triangular, trapezoidal, or other non-circular cross sections. Further, first, second, third, and fourth through-holes 28, 34, 40, and 46 do not have to extend diametrically through outer periphery 26 of rope fixer 20 or extend through the longitudinal axis of rope fixer 20. Further, first, second, third, and fourth through-holes 28, 34, 40, and 46 can have differing diameters. As an example, the inner diameter of first through-hole 28 can be slightly larger than the outer diameter of the rope and slightly larger than the inner diameters of second, third, and fourth through-holes 34, 40, and 46, such that the rope can be more easily extended through first through-hole 28. The spacings between first, second, third, and fourth through-holes 28, 34, 40, and 46 can be different. Further, first, second, third, and fourth through-holes 28, 34, 40, and 46 do not have to be parallel to each other. Namely, first openings 30, 36, 42, and 48 of first, second, third, and fourth through-holes 28, 34, 40, and 46 can be spaced from each other in a circumferential direction and along the longitudinal axis. Likewise, second openings 32, 38, 44, and 50 of first, second, third, and fourth through-holes 28, 34, 40, and 46 can be spaced from each other in a circumferential direction and along the longitudinal axis. This provides increased friction to the rope mounted to rope fixer 20.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A rope fixer comprising first and second ends spaced along a longitudinal axis and an outer periphery extending between the first and second ends, with the rope fixer further including first, second, and third through-holes extending through the outer periphery and spaced from each other along the longitudinal axis, with each of the first, second, and third through-holes including first and second openings spaced in a circumferential direction surrounding the longitudinal axis, with the rope fixer adapted to frictionally retain a section of a rope, with the section of the rope adapted to extend through the first, second, and third through-holes.

2. The rope fixer as claimed in claim 1, with the rope fixer further including a fourth through-hole extending through the outer periphery, with the first through-hole located adjacent the first end, with the fourth through-hole located adjacent the second end, with the second and third through-holes located between the first and fourth through-holes, with the second through-hole located between the first and third through-holes.

3. The rope fixer as claimed in claim 2, with a first spacing between the first and second through-holes along the longitudinal axis being in a range of 0.5 to 1 times a second spacing between the second and third through-holes along the longitudinal axis, with a third spacing between the third and fourth through-holes along the longitudinal axis being in a range of 0.5 to 1 times the second spacing between the second and third through-holes.
